(19) United States
(12) Patent Application Publication
(10) Pub. No.: US 2005/0150932 A1
(43) Pub. Date: Jul. 14, 2005

(54) Arrangement for wire bonding and method for producing a bonding connection

(76) Inventor: Khalil Hosseini, Weihmichl (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/504,246

(22) PCT Filed: Feb. 5, 2003
(86) PCT No.: PCT/DE03/00325

(30) Foreign Application Priority Data
Feb. 11, 2002 (DE) 102056099

(51) Int. Cl. B23K 31/02

(52) U.S. Cl. 228/180.5

(57) ABSTRACT

The invention relates to a wire-bonding process and to a process for producing a bonded joint. A bonding location is heated by means of a laser beam originating from a laser, the arrangement comprising an ultrasonic wedge-wedge bonding unit with a bonding needle, a copper or aluminum bonding wire guide, and a copper or aluminum wire for an ultrasonic wedge-wedge bonding process, and at least one of the bonding locations having a hard-metal coating.

### BACKGROUND

The invention relates to an arrangement for wire bonding with heating of the bonding location, and to a process for producing a bonded joint.

Document DE 43 37 513 C2 has disclosed an arrangement for heating a bonding location by gold wire thermosonic wire bonding. To lower the process temperature from over 240 degrees C. to less than 170 degrees C., the bonding location is irradiated by means of a laser beam, which originates from a laser and is guided via an optical waveguide, for gold wire thermosonic wire bonding. Unlike gold wire bonding, which takes place at elevated temperature, copper or aluminum wire bonding is carried out at room temperature. The bonding energy required is obtained from an ultrasound source and is sufficient to bond copper or aluminum bonding wire to metallic surfaces of a copper, aluminum or gold coating. As part of the ongoing attempts to reduce costs by using other, less expensive bonding location materials, such as soft copper materials or hard metals, such as phosphorus-alloyed nickel, as bonding location for copper or aluminum bonding wires, unexpected problems have arisen leading to increased scrap rates and failure of the bonded joints.

### SUMMARY

One embodiment of the invention provides an arrangement for wire bonding using copper or aluminum bonding wire and to give a process for producing a bonded joint using copper or aluminum bonding wire, in which the scrap rate and the frequency of defective bonded joints are reduced.

The invention provides an arrangement for wire bonding by heating a bonding location by means of a laser beam which originates from a laser and is guided via optical waveguide optics. For this purpose, the arrangement has an ultrasonic wedge-wedge bonding unit with a bonding needle, a bonding wire guide and a copper or aluminum wire for an ultrasonic wedge-wedge bonding unit. In the arrangement, at least one of the bonding locations has a hard-metal coating, and the optical waveguide optics are directed onto the hard-metal coating.

With this arrangement, the problematic hard-metal coating is no longer joined to a copper or aluminum bonding wire at room temperature, but rather the surface of the hard-metal coating is softened by the laser beam, so that after bonding an intensive bonded joint, which is capable of recrystalization, can be realized between the hard-metal coating and copper or aluminum bonding wire. Intensive tests carried out on previous failures have established that two crystallographic causes are responsible for the failures. In the case of soft-metal coatings at the bonding location, microcracks and brittle intermetallic compounds, for example between the aluminum of the bonding wire and the soft copper of the bonding location, are produced in the recrystalization phase. The embrittlement is also based on the fact that copper diffuses into the recrystalizaton phase of the bonding region, where it causes embrittlement microcracking.

To prevent oxidation of copper or diffusion of copper into the bonded joint, the bonding surface of the critical bonding location may be provided with a hard-metal coating, for example, of nickel/phosphorus, with the hard-metal coating shielding the bonded joint location from copper oxidation and diffusion. However, this produces new problems which reveal the copper and aluminum bonding wire lifting off the bonding location as soon as the copper and aluminum bonding wire has to be detached from the bonding needle after bonding has been carried out. With the device according to one embodiment of the invention, this lift-off effect during detachment of the copper and aluminum bonding wire to finish production of the bonded joint can be overcome, and recrystalization of the partners in the joint produces a stable joint using the ultrasonic wedge-wedge bonding unit if the bonding location and therefore the hard-metal surface are softened by means of a laser beam.

The copper and aluminum bonding wire may include an alloy, in order on the one hand to improve the elasticity of the bonding wire and on the other hand to reduce the susceptibility of the copper and aluminum to oxidation.

Since copper and aluminum bonding wires cover a wide diameter range from 25 μm to over 750 μm, there is furthermore provision for a notching tool for introducing a notch into the aluminum bonding wire to be provided in the arrangement for wire bonding with an aluminum bonding wire. This notching tool is activated if the diameter of the aluminum bonding wire exceeds 100 μm, and then produces a notch which reduces the cross section which has to be detached after bonding of the aluminum bonding wire to less than 100 μm. Furthermore, arranging a notching tool in the arrangement according to one embodiment of the invention reduces the problem of lift-off after bonding, since the detachment forces acting on the bonding wire are lower.

Furthermore, the wavelength of the laser light may be matched to the absorptive power of the hard-metal coating or chip metallization. The laser energy is favorably applied to the crystal lattice of the hard-metal coating and chip metallization and excites the lattice atoms to greater vibration, which is associated with (partial) softening of the surface of the hard-metal coating and chip metallization.

The dimensions of the optical waveguide optics may be such that the diameter of a heating spot can be set proportionally to the diameter of the aluminum wire. Furthermore, this capacity for setting the heating spot provides that in each case a sufficiently large bonding surface area for application of the copper and aluminum bonding wire is softened. The proportionality factor between the diameter of the heating spot and the diameter of the copper and aluminum bonding wire is in this case in an order of magnitude of from 1.2 to 1.8, which means that the heating spot is between 20 and 80% larger than the diameter of the copper or aluminum bonding wire.

Since the wire-bonding arrangement operates with a bonding needle which moves to different bonding positions on a semiconductor chip and on a substrate carrier, while at the same time the bonding height may differ between the two points or bonding locations to be bonded, in some embodiments the arrangement has a guide for the bonding needle and a guide for the optical waveguide optics, which are mechanically coupled to one another. As a result, the optical waveguide optics are reliably guided with the bonding needle to the respective bonding locations. In this context, the mechanical coupling may be configured in such a way that the two guide units for bonding needle and optical waveguide optics are decoupled from one another in terms of ultrasound. To heat the hard-metal coating or chip metallization at the bonding location, it is sufficient for the laser to have a pulsed laser generator, so that the lattice of the hard-metal and of the chip metallization is excited in a pulsed manner, so that the surface of the bonding location softens, especially since lattice vibrations (phonons) decay more slowly than the pulsed excitation by the laser beam.

A process for producing a bonded joint using a copper or aluminum bonding wire includes the following process steps. First of all, at least one of the bonding locations is coated with a hard metal, in order to achieve protection against oxidation and a diffusion barrier between the copper or aluminum bonding wire and electrically conductive material beneath it. Furthermore, to prepare the bonded joint, the ultrasonic wedge-wedge bonding unit is fitted with a copper or aluminum bonding wire. Then, a first ultrasonic wedge bonded joint is carried out by laser energy being supplied without the aluminum bonding wire being detached. Then, the bonding needle with copper or aluminum bonding wire is guided, synchronously with optical waveguide optics, up to a search height for a second bonding location with hard-metal coating. When the search height is reached, the laser can be switched on again, in order to heat the bonding location, and remains switched on while the bonding needle and the optical waveguide optics are moved downward onto the bonding position. The ultrasonic wedge bonding of the copper or aluminum bonding wire to the hard-metal coating of the second bonding location then takes place in the bonding position, with the second bonding location having a softened surface as a result of the use of the optical waveguide optics at this location.

After ultrasound energy has been introduced and brief recrystalization has taken place, the bonding needle, together with the optical waveguide optics, are lifted off the second bonding location, with the copper or aluminum bonding wire being detached from the bonding needle. When the bonding needle is being lifted off the bonded joint between hard-metal coating and copper or aluminum bonding wire is retained, and the copper or aluminum bonding wire does not lift off the hard-metal coating, breaking the bonded-joint location.

The hard-metal coating itself may, for example for at least one second bonding location, be effected by means of a sputtering process or by electroplating or may be applied by vapor deposition. A phosphorus-alloyed nickel, which serves as a diffusion barrier between the bonding wire material comprising an aluminum wire and the material of a conductor track or flat conductor which is to be connected to the bonding wire, can be applied both using the sputtering technique and using the vapor deposition technique. A further process for applying the hard metal is formed by printing, in which a hard-metal mixture is applied in the form of a paste and is then sintered together to form a coating in a short heat-treatment step.

In a further implementation of the process, the detachment of the aluminum bonding wire can be facilitated by forming a notch in the aluminum bonding wire, which has a wire diameter of over 100 μm.

At least one embodiment of the invention improves the adhesion and bond quality with wedge-wedge wire bonding using ultrasound, and realizes improved bonding properties on hard and sensitive surfaces. Furthermore, the reliability of the bonded joint is increased by the recrystallization with different bonding partners at the interface. Furthermore, the problem is solved of wire lift-off from hard surfaces without the ultrasound power having to be increased, which measure in part leads to a deterioration in the bond quality, in particular on lead frames.

Increasing the ultrasound power in order to achieve better bonding results for a copper or aluminum bonding wire has the effect, on soft-metal coatings at a bonding location, of damaging the chip metallization, and consequently there are limits on the extent to which the ultrasound power can be increased in order to improve the bonded joint. To this extent, the heating of the bonding surface using a laser in accordance with one embodiment of the invention is an effective way of stabilizing and improving the bonding process, i.e. the surface is heated by the laser beam during what is known as the “touch down” of the bonding needle by the laser beam. The heating of the surface softens the hard metal microstructure, leading to embedding and bonding of the copper or aluminum bonding wire on the substrate or in the coating of the bonding location. This reduces the risk of lift off, and allows bonding to sensitive surfaces to be carried out using a lower ultrasound power, so that the risk of microcracks being formed in a soft chip metallization is avoided.

Furthermore, it should be noted that in the process according to one embodiment of the invention, the laser is only deployed once the bonding needle has reached the search height. This is effected through optical waveguide optics which are fitted to the bonding needle and are acted on by a pulsed laser beam. The pulse sequence of the laser beam can be adapted by suitable software as a function of the condition of the surface and the size of the bonding area. Therefore, the process according to one embodiment of the invention produces a locally soft surface while the bonding needle is moving toward the surface. To protect both the bonding wire and the bonding location from oxidation and sulfidation, it is possible for the bonding location to be purged with a shielding gas atmosphere throughout the entire bonding operation.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description.

The elements of the drawings are not necessarily to scale relative to each other. Like reference numerals designate corresponding similar parts.

FIG. 1 illustrates an outline sketch of an arrangement for wire bonding with heating of a first bonding location.

FIG. 2 illustrates an outline sketch of an arrangement for wire bonding with heating of a second bonding location.

FIG. 3 illustrates an outline sketch of an arrangement for wire bonding after a bonding joint has been completed.

FIG. 4 illustrates an outline sketch of an arrangement for wire bonding in which the bonding wire lifts off the second bonding location in the event of the laser heating failing.

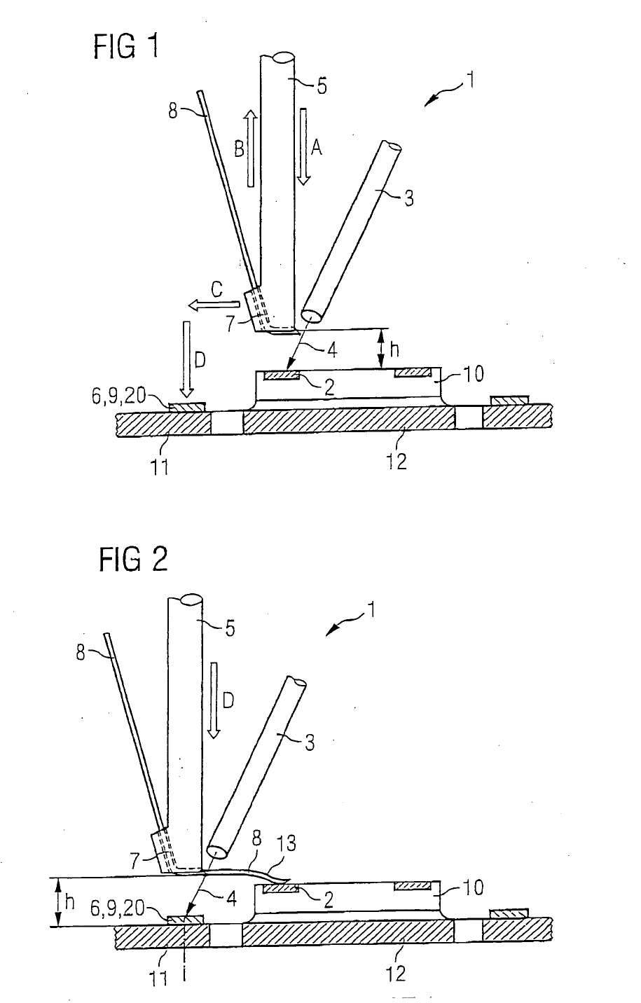

FIG. 1 illustrates an outline sketch of an arrangement 1 for copper or aluminum wire bonding with heating of a first bonding location 2. Reference numeral 3 denotes optical waveguide optics which can be used to illuminate and heat the bonding location 2 by means of a laser beam 4. Reference numeral 5 denotes a bonding needle, at the tip of which a copper or aluminum bonding wire 8 is held in a copper or aluminum bonding wire guide 7. As soon as the search height h at a predetermined distance from the bonding location 2 is reached, the laser beam 4 is switched on and concentrated onto the bonding location 2 through the optical waveguide optics.

While the bonding needle 5 is moving onto the bonding location 2 in the direction indicated by arrow A, the laser beam 4 remains switched on and heats the bonding location. The heating of the bonding location facilitates bonding at a low ultrasound energy. This ultrasound energy is transmitted via the bonding needle 5 to the copper or aluminum bonding wire 8 and effects cold-welding surfaces of the bonding wire 8 and the surfaces of the metal of the bonding location 2. After a first bonded joint has been produced, the bonding needle is raised in the direction indicated by arrow B and moved in the direction indicated by arrow C, in order to be positioned above the second bonding position 20.

While the first bonding position with bonding location 2 is arranged on a semiconductor chip 10, the second bonding location 20 is located on a flat conductor 11 of a lead frame 12 made from copper. The second bonding location 20 is coated with a hard metal 9 comprising phosphorus-alloy nickel, in order to prevent oxidation and diffusion of the copper material of the lead frame 12 to the bonding location of the copper or aluminum bonding wire. Before the bonding needle 5 is lowered onto the hard-metal coating 6 of the second bonding location 20 in the direction indicated by arrow D, therefore, the optical waveguide optics 3 are fed with laser light so as to heat the surface of the hard-metal coating 6, with the result that the properties of the hard-metal coating 6 change in such a manner that the hardness of the surface decreases.

FIG. 2 illustrates an outline sketch of an arrangement for wire bonding with heating of a second bonding location. Components with the same functions as in FIG. 1 are denoted by the same reference numerals and are not explained once again.

On account of the relative movements of the bonding needle 9 with respect to the bonding locations 2 and 20 in the directions A, B, C and D illustrated in FIG. 1, the copper or aluminum bonding wire 8 which has been bonded to the first bonding location 2 is pulled through the bonding wire guide 7 and forms a bonding wire bend 13 which is sufficient to lead the aluminum bonding wire 8 to the second bonding location 20 without tensile stresses. After the search height h for the second bonding location 20 has been reached, the laser supply is switched on again and a pulsed laser beam 4 heats the surface of the hard-metal coating 6, so that the hardness is reduced and the bonding needle 5 can be lowered onto the bonding position of the second bonding location 20 in the direction indicated by arrow D.

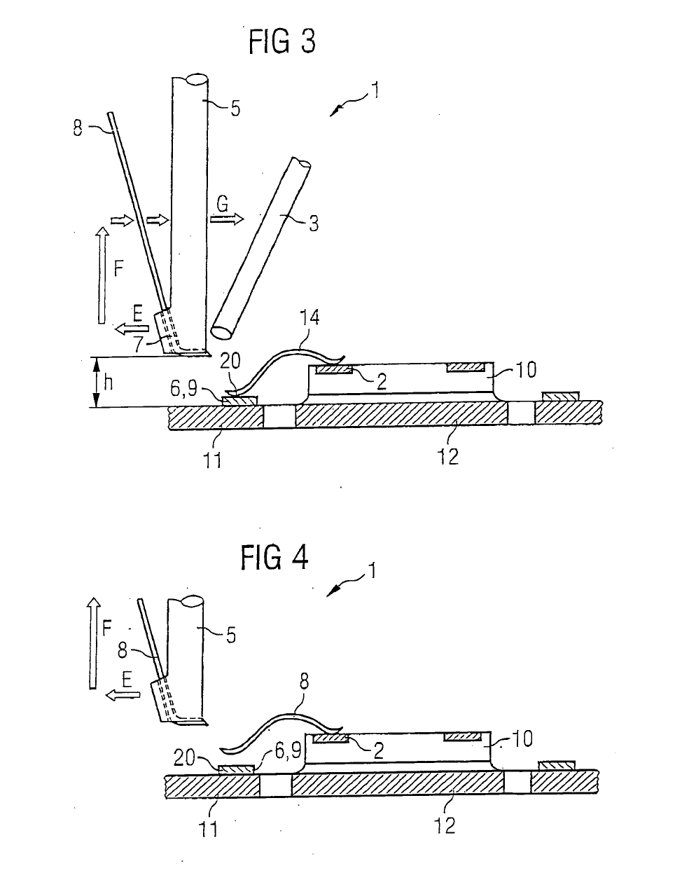

FIG. 3 illustrates an outline sketch of an arrangement for wire bonding after completion of a bonded joint 14. Components with the same functions as in the previous figures are denoted by identical reference numerals and are not explained once again.

For this purpose, the bonding needle 5 is guided away from the bonding location 20, in the direction indicated by arrow E, with the copper or aluminum bonding wire 8 being detached behind the bonding location 20. If the thickness of the copper or aluminum bonding wire 8 is greater than 100 μm, a notching tool arranged in the copper or aluminum bonding wire guide 7 is activated, so as to introduce a notch into the copper or aluminum bonding wire 8 before the bonding needle 5 is guided away in direction E. If the thickness of the copper or aluminum bonding wire 8 is less than 100 μm, the notching tool is not activated, since the bonding wire can slide past the notching tool in the copper or aluminum bonding wire guide 7.

After the copper or aluminum bonding wire 8 has been successfully detached, the bonding needle 5 can be raised in the direction indicated by arrow F and return to its starting position, illustrated in FIG. 1, in the direction indicated by arrow G. Since the directions of movement in the directions indicated by arrows A to G are relative movements between bonding needle 5 and bonding locations 2, 20, it is also possible for the lead frame with the first and second bonding locations 2 and 20, respectively, to be moved instead of the bonding needle 5. One possible division of the directions of movement X, Y and Z in a Cartesian coordinate system in an arrangement for an ultrasonic wedge-wedge bonding unit may consist in the bonding needle 5 carrying out all the vertical movements in the Z direction, while the lead frame with the bonding locations 2, 20 is moved in the lead frame play in the X and Y directions.

FIG. 4 illustrates an outline sketch of an arrangement for wire bonding in which the bonding wire lifts off the second bonding location if the laser heating is absent. Components with the same functions as in the previous functions are denoted by identical numerals and are not explained once again.

If the heating of a hard-metal coating by a laser is omitted, there is a risk that, when the bonding needle 5 is being guided away in the direction indicated by arrows E and F, the bonding wire 8 will not just be detached but also at the same time will lift off from the bonding location 20, with the result that the bonding joint is not perfect. This defect, as illustrated in FIG. 4, can be avoided by the use of heating of the surface of the hard metal 9 in the second bonding position 20, as illustrated FIGS. 2 and 3.

1. A process for producing a bonded join using a copper bonding wire (8) which comprises the following process steps:
coating at least one of the bonding locations (2, 20) with a hard metal (9),
mounting a copper bonding wire (8) in an ultrasonic wedge-wedge bonding unit,
carrying out a first ultrasonic wedge bonding join by supplying laser energy without detaching the copper bonding wire (8),
guiding a bonding needle (5) with copper bonding wire (8) synchronously with optical waveguide optics (3) up to a search height (h) above the bonding location (2) of the hard-metal coating (6),
switching on a laser in order to heat the bonding location (2),
moving the bonding needle (5) and optical waveguide optics (3) downward, with the laser switched on, into a bonding position with the hard-metal coating (6) at the bonding location (20),
ultrasonic wedge bonding of the copper bonding wire (8) to the hard-metal coating (6),
lifting the bonding needle (5) and the optical waveguide optics (3) off the second bonding location (2), with the copper bonding wire (8) being detached from the bonding needle.

2. Process according to claim 1, characterized in that the coating of at least one bonding location (2, 20) with a hard metal (9) is carried out by means of sputtering processes or by electroplating.

3. The process as claimed in claim 1, characterized in that the coating of at least one bonding location (2, 20) with a hard metal (9) is carried out by means of vapour deposition.

4. The process as claimed in claim 1, characterized in that the coating of at least one bonding location (2, 20) with a hard metal (9) is carried out by means of printing technology.

5. The process as claimed in one of claims 1 to 4, characterized in that the detachment of the copper bonding wire (8) when the bonding needle (5) is being lifted off, for wire diameters of over 100 μm, is carried out after prior notching of the copper bonding wire (8),
